(19) United States
(12) Patent Application Publication
(10) Pub. No.: US 2024/0268595 A1
(43) Pub. Date: Aug. 15, 2024

(54) OVERBOIL PROTECTION DEVICE

(71) Applicant: Aaron Charles Anches, Seattle, WA (US)

(72) Inventor: Aaron Charles Anches, Seattle, WA (US)

(21) Appl. No.: 18/409,930

(22) Filed: Jan. 11, 2024

Related U.S. Application Data
(60) Provisional application No. 63/445,356, filed on Feb. 14, 2023.

(51) Int. Cl. A47J 27/56; A47J 37/10; F04D 17/08; F04D 25/06

(52) U.S. Cl. CPC A47J 27/56; A47J 37/108; F04D 17/08; F04D 25/06

(57) ABSTRACT

The present invention relates to an overboil protection device removably couplable to a cooking utensil. The overboil protection device includes blower fan(s) configured to provide forced air to food items placed on a cooking surface of the cooking utensil, an electrical power source providing electric power to the blower fan(s), a clip element or an attachment element that couples the overboil protection device to the cooking handle of the cooking utensil, a mount element positioned between the blower fan(s) and the clip element. The overboiling protection device prevents food item from being overboiled and reaching overspill stage. The overboiling protection device does not make any physical contact with the food item placed in the cooking utensil.

### CROSS-REFERENCE TO RELATED APPLICATIONS

The present application hereby claims priority to and incorporates by reference the entirety of the disclosures of the provisional application No. 63/445,356 entitled “OVERBOIL PROTECTION DEVICE” filed on Feb. 14, 2023.

### BACKGROUND OF THE INVENTION

The present invention relates to the field of cooking and, more particularly, the present invention relates to an overboil protection device that prevents liquid overboiling in a cooking utensil utilizing constant mechanical conveyance of ambient air.

### BACKGROUND

Cooking of food items generally involves a cooking utensil comprising food item to be heated, and a heating arrangement such as but not limited to: cook-top, burner, stove, campfire, and so on, wherein the cooking utensil comprising food item is heated using the heating arrangement.

Food items, liquid in nature such as but not limited to milk, soup, coffee, tea, oatmeal, and so on are required to be observed with care while cooking to avoid spilling due to overboiling of these food items. The spilling of food items creates an unhygienic environment that is difficult to clean as well as reduces the amount of food items to be served. Further, the spilling of food items can compromise kitchen safety and thus, lead to environmental hazards such as burns and scalds.

Existing overboil protection devices rely on their direct contact with the over-boiling liquid in an attempt to dissipate the bubbles of the food item by forcing them to break before overspilling or by manipulating the size and number of bubbles produced. For instance, silicone covers rely on the bubbles being forced through multiple holes. However, these silicone covers become messy due to direct contact with the foam and do not allow access to view or stir liquid/food as well as adding another item to clean up. In another example, ceramic discs are placed directly in the cooking pot/pan and these ceramic discs claim to naturally modify the size and number of bubbles rising to the top of the pot preventing overboiling. However, ceramic discs are not so effective solution for preventing overboiling.

Another solution known in the art for liquid overboiling protection requires placing a wooden spoon over the top of the pot in an attempt to dissipate the bubbles by direct contact with a presumably cooler surface of the wooden spoon, which is again unreliable and ineffective.

Yes, another solution known in the art for liquid overboiling protection requires adding oil to the pot to break the surface tension of the liquid molecules, thereby preventing the water from foaming up and boiling, and spilling out of the pot. However, adding oil to the pot can lead to changes in food quality and is also not so effective solution.

The existing solutions related to overboiling protection are unreliable, ineffective, and inefficient. There is a need for an effective and efficient overboiling protection device that solves the problem of liquid overboiling in a cooking utensil without making any physical contact with the food item placed inside the cooking utensil.

Thus, a new overboiling protection device is proposed that solves the problem of liquid overboiling which is being boiled in a cooking utensil. The proposed new overboiling protection device uses constant mechanical conveyance of ambient air on top of the food item and does not make any physical contact with the food item placed in the cooking utensil.

### SUMMARY

While the way that the present disclosure addresses the disadvantages of the prior art will be discussed in greater detail below, in general, the present disclosure provides an overboiling protection device removably couplable to the handle of a cooking utensil.

The present disclosure overcomes the drawbacks of the existing devices by providing an overboil protection device that is removably couplable to a cooking utensil. The overboil protection device includes at least one blower fan configured to provide forced air to food items placed on a cooking surface of the cooking utensil, an electrical power source configured to provide electric power to at least one blower fan, a clip element configured to removably attach the overboil protection device to a cooking handle of the cooking utensil, and a mounting element positioned between the blower fan and the clip element.

An object of the present disclosure is to provide an overboil protection device that does not make physical contact with the food item.

Another object of the present disclosure is to provide an overboil protection device that eliminates the need for manual cooking of a food item by a user, thereby improving the hygiene of the kitchen environment.

Yet another object of the present disclosure is to provide an overboil protection device that is electrically powered to reduce manual labor and effort.

The further object of the present disclosure is to provide an overboil protection device that is easy to attach and detach to and from a cooking utensil.

The further object of the present disclosure is to provide an overboil protection device that is used for cooling hot food items.

An embodiment of the present invention discloses an overboiling protection device removably couplable onto a cooking handle of a cooking utensil. The overboiling protection device includes at least one blower fan configured to provide forced air directed towards food items placed on a cooking surface of the cooking utensil, an electrical power source configured to power the at least one blower fan, a clip element configured to be removably attached to the cooking handle of the cooking utensil, thereby mounting the overboiling protection device to the cooking handle, and a mount element positioned between the at least one blower fan and the clip element.

The present disclosure overcomes the drawbacks of the existing devices by providing a simple and easy to use device for overboil protection as well as for cooking food items.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the figures, and

FIG. 1 is a front perspective view of an overboiling protection device removably attached to a cooking utensil, according to an embodiment of the present invention.

FIG. 2 is a front view of the overboiling protection device removably attached to a cooking utensil, according to an embodiment of the present invention.

FIG. 3 is a bottom perspective view of the overboiling protection device removably attached to the cooking utensil, according to an embodiment of the present invention.

FIG. 4 is a side view of the overboiling protection device depicted in FIGS. 1-3.

FIG. 5 is a bottom view of the overboiling protection device depicted in FIGS. 1-3.

FIG. 6 is a front view of the overboiling protection device depicted in FIGS. 1-3.

FIGS. 7-9 are front perspective view, and back perspective views of an overboiling protection device removably attached to a cooking utensil, according to another embodiment of the present invention.

### DETAILED DESCRIPTION

The following description is of exemplary embodiments of the invention only and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

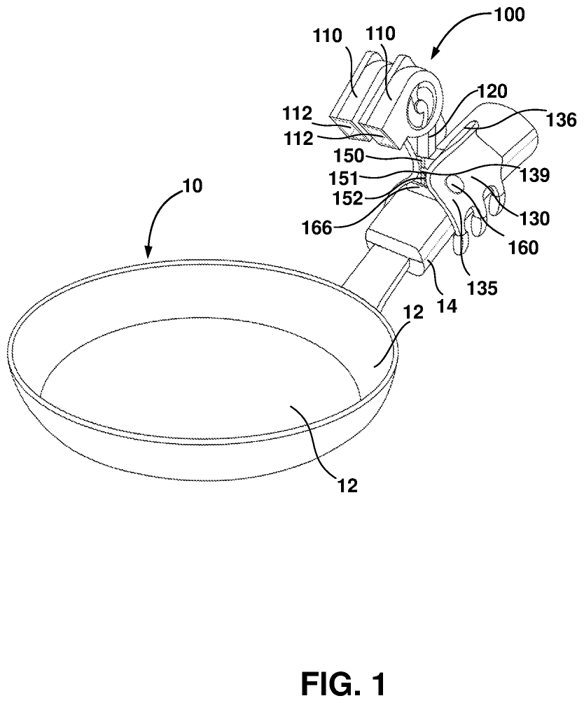

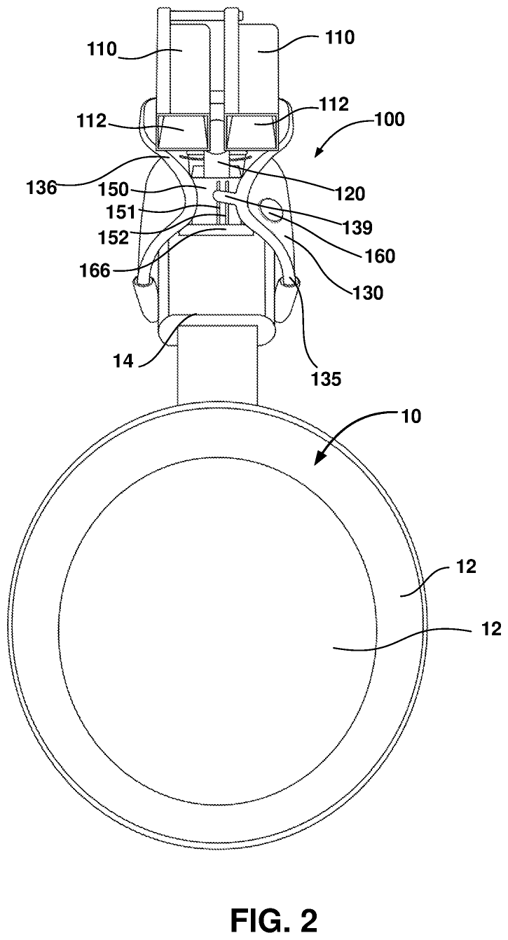

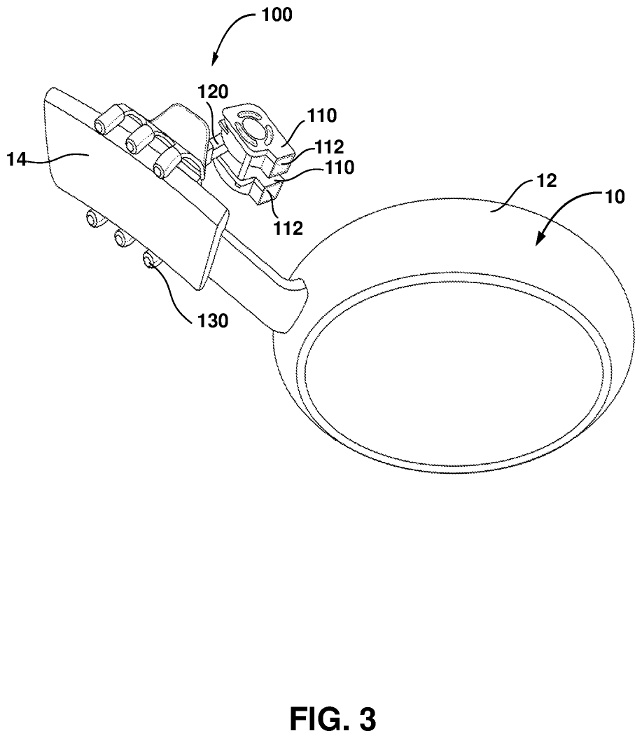

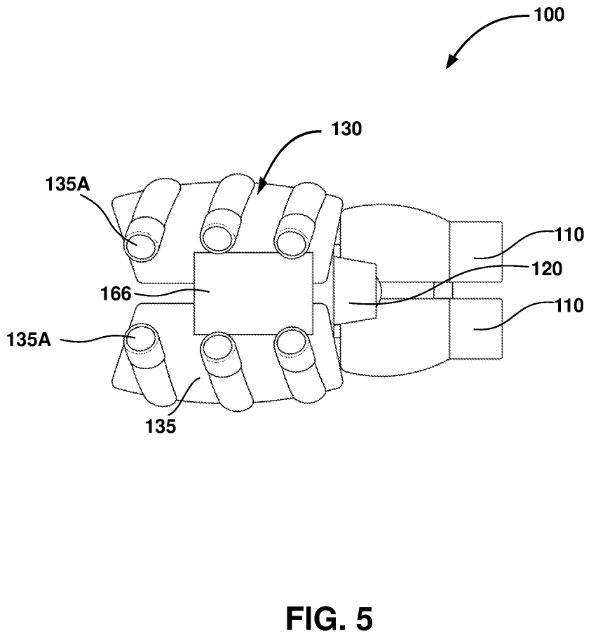

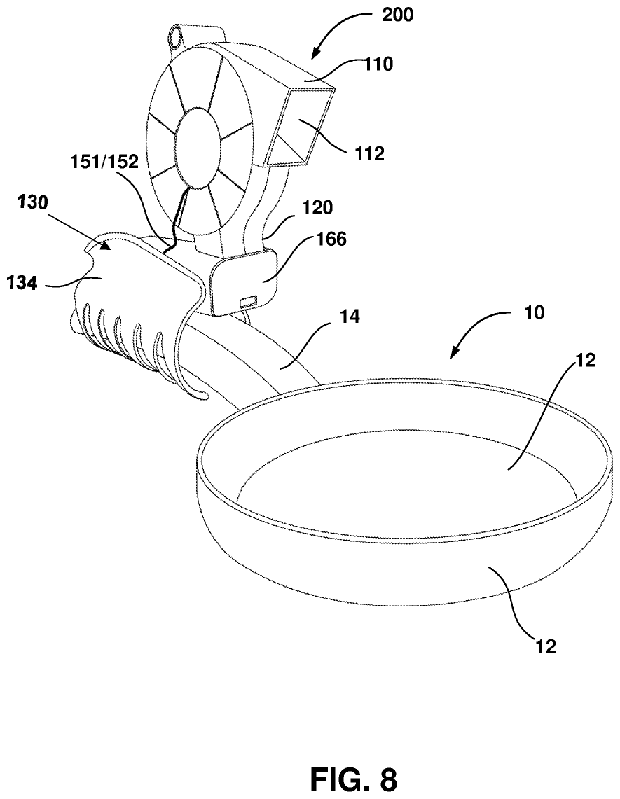

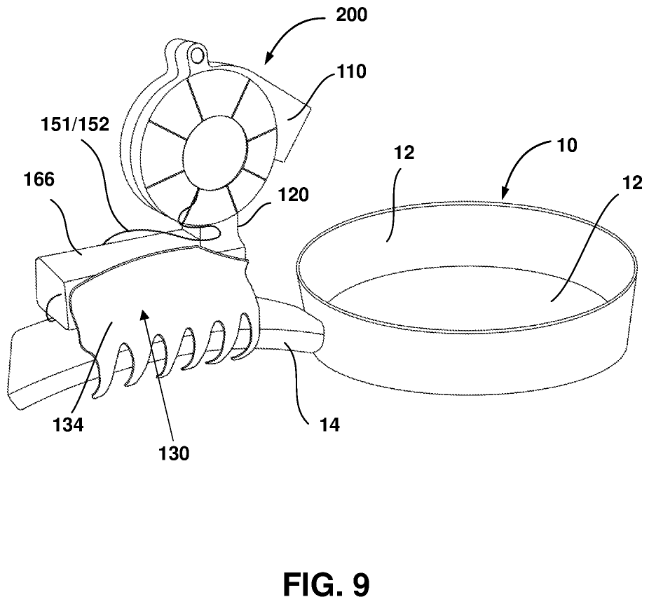

The overboiling protection device of the present invention will now be described with reference to the accompanying drawings, particularly FIGS. 1-9.

Reference is initially made to FIGS. 1-3 that illustrates a front perspective view, a front view, and a bottom perspective view of an overboiling protection device 100 removably attached to a cooking utensil 10, according to an embodiment of the present invention. As shown in FIGS. 1-3, the overboiling protection device 100 is removably attached to a cooking utensil 10 in the engaged position. The cooking utensil 10 is any conventional cookware capable of being used for placement of food items (not shown in figures) and the cooking utensil 10 may include but is not limited to a cooking pan, a cooking pot, a saucepan, a cauldron, a kettle, a wok and so on. The cooking utensil 10 comprises a cooking surface 12 configured for handling food items and a cooking handle 14 for providing a resting/supporting surface for placement of the overboiling protection device 100 that will be described in greater detail in the below description.

According to an embodiment, as shown in FIGS. 1-6, the overboiling protection device 100 includes a pair of blower fans 110 positioned in a side-by-side relationship, and a clip element 130 configured to be removably attached to the cooking handle 14. A mount element 120 is configured to adjust the position and/or rotational orientation of the pair of blower fans 110 relative to the clip element 130. However, it should be understood that the number of blower fans 110 can be any arbitrary number greater than one in various other embodiments (not shown in figures) of the present invention.

The pair of blower fans 110 are capable of providing forced air circulation directed towards the food item (not shown in figures) placed in the cooking surface 12 of the cooking utensil 10. Each blower fan 110 comprises a duct 112 to direct ambient air towards the cooking surface 12 in a forced manner. Each of the blower fan 110 is configured to immediately and effectively cool and condense the layer of steam that interacts with the starch in the food item that causes overboiling before the food item can even reach the overspill stage. This forced conveyance of ambient air provided by each of the blower fan 110 eases the surface tension of the food item, thereby constantly returning the rising foam of the food item placed in the cooking surface 12 to a liquid state and dissipating the food item back into the cooking utensil 10. The pair of blower fans 110 generally have a small size and may have any number of blades. The pair of blower fans 110 includes any machine capable of directing ambient air towards the food item (placed on the cooking surface 12 of the cooking utensil 10). The machine for the purpose of this invention can include but is not limited to an axial flow fan, centrifugal fan, cross flow fan, blade-less fan, and so on depending on the user's requirements. Further, it should be understood that each of the blower fans 110 comprises various elements necessary for efficient working of the blower fan 110 and such elements may include but not limited to: motor, rotor, vane, blade, wiring, shaft, controller, and so on.

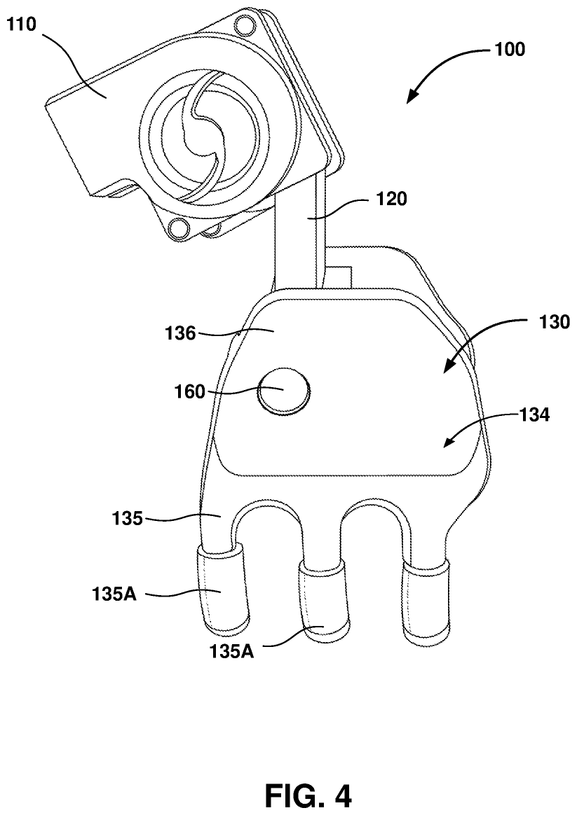

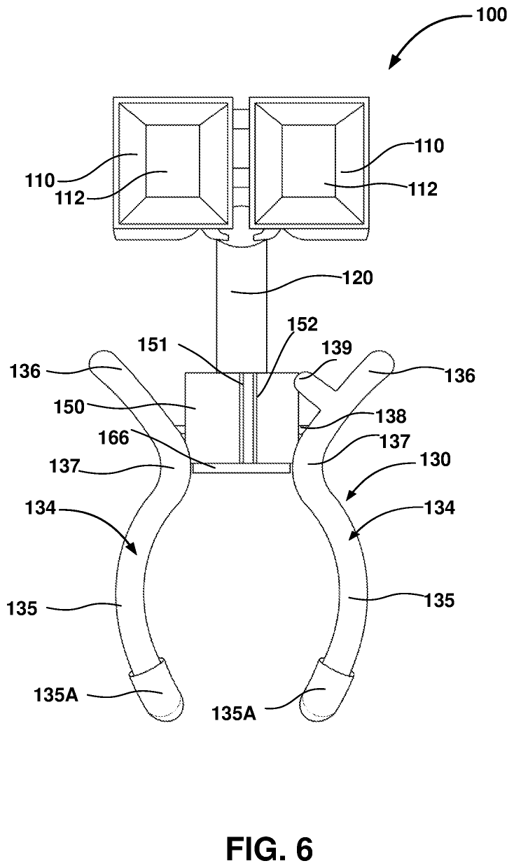

Referring now to FIGS. 4-6, the clip element 130 comprises a pair of jaws 134. Each of the jaw 134 selected from the pair of jaws 134 comprises a jaw element 135 configured to engage against the cooking handle 14, a grip element 136 configured to be manipulated by the hands of the user, and an intermediate element 137 rotationally connected to a biasing element 138 (FIG. 6). The jaw element 135 comprises a plurality of non-slip (high friction) coated tines 135A for enabling a secure and efficient removable attachment (connection) between the jaw element 135 and the cooking handle 14 (FIG. 1-3). At least one of jaw 134 selected from a pair of jaws 134 further comprises an electrical connection port 139 located in the grip element 136. The functionality of the port 139 will be described in detail in the below description. A jaw 134 selected from the pair of jaws 134 further comprises an LED unit 160 that will be described in detail in the below description.

The jaw elements 135 of the pair of jaws 134 can be selectively positioned in either one of an engaged position (FIGS. 1-3) or a disengaged position (FIG. 6). In the engaged position (FIGS. 1-3), the jaw elements 135 of the pair of jaws 134 are distanced apart to removably receive a cooking handle 14 (FIG. 1-3). In the disengaged position (FIG. 6), the jaw elements 135 are brought closer to each other such that the cooking handle 14 (FIG. 1-3) may not be received (fitted) between the pair of jaw elements 135 of the pair of jaws 134. The user can inwardly press the grip elements 136 of the pair of jaws 134 to move the jaw elements 135 of the pair of jaws 134 in the outward direction, thereby enabling the pair of jaw elements 135 to be distanced apart to removably receive the cooking handle 14 (FIG. 1-3), thereby bringing the pair of jaws 134 in the engaged position.

The biasing element 138 (partially visible in FIG. 6) is positioned between the pair of the intermediate elements 137 of the pair of jaws 134. The biasing element 138 is not shown in majority of figures for simplicity and ease of understanding of the invention. The biasing element 138 extends along a substantial portion of the width of the pair of jaws 134 to enable the pair of jaws 134 to be rotationally coupled to each other. The biasing element 138 is further configured to automatically bring the pair of jaws 134 in the disengaged position unless acted upon by a force sufficient to overcome the resilient force provided by the biasing element 138. Thus, the user can bring the pair of jaw elements 135 in the disengaged position (FIG. 6) by further inwardly pressing the pair of grip elements 136 of the pair of jaws 134 to move the pair of jaw elements 135 of the pair of jaws 134 in the outward direction, thereby enabling the pair of jaw elements 135 to be distanced apart and then, the user can remove the cooking handle 14 from the pair of jaw elements 135. Then, the resilient force provided by the biasing element 138 automatically (naturally) brings the pair of jaw elements 135 to the disengaged position as shown in FIG. 6.

In a preferred embodiment, the biasing element 138 is a torsion spring. In another embodiment, the biasing element 138 may include hinges, leaf springs, bellows, gas springs, helical springs, and so on.

In a preferred embodiment, the biasing element 138 extends along the entire width of the pair of jaws 134 to enable the pair of jaws 134 to be rotationally coupled to each other.

The mount element 120 is positioned between the pair of blower fans 110 and the clip element 130. The mount element 120 may include any mechanism that is capable of adjusting the position and/or rotational orientation of the pair of blower fans 110 relative to the clip element 130. In an embodiment, the mechanism of the mount element 120 is a ball-socket joint that may provide three degrees of freedom to enable the pair of blower fans 110 to rotate relative to the clip element 130 along three axes, namely the x-axis, y-axis, and z-axis. Further, other mechanisms of the mount element 120 can be envisioned that are capable of adjusting the spatial position and/or rotational orientation of the pair of blower fans 110 relative to the clip element 130 and such mechanisms have at least one degree of freedom. Such mechanisms may include but not limited to: slider mechanism, universal joints, revolute (rotary) joints, Stewart platform, swivel joints, piston-cylinder mechanisms, and so on.

In another embodiment, the mount element 120 is rigidly positioned between the pair of blower fans 110 and the clip element 130 such that the position and/or rotational orientation of the pair of blower fans 110 remains unchangeable relative to the clip element 130.

The pair of blower fans 110 are electrically powered by an electrical power source, that includes a battery 165 (not shown in figures). The battery 165 is preferably enclosed inside a battery casing 166. An integrated cable wire (not shown in figures) extends from the battery 165 to the electrical connection port 139 of the grip element 136 of the jaw(s) 134. Thus, the electrical connection port 139 of the grip element 136 of the jaw(s) 134 is configured to provide electric power provided by the battery 165 (not shown in figures) to the pair of blower fans 110 that will be further described in the below description.

In another embodiment (not shown in figures), the pair of blower fans 110 are electrically powered by an electrical cord that is further electrically connected to an electric socket available at the residential/commercial facilities. Thus, the pair of blower fans 110 are configured to be powered in a Plug-and-play manner by an electrical power source that is connected to the AC/DC electricity supply of the residential/commercial facility.

In an embodiment as shown in FIGS. 1-6, an integrated switch mechanism 150 is configured to electrically connect and disconnect the battery 165 (not shown in figures) to/from the pair of blower fans 110 such that the rotation of the pair of blower fans 110 are electrically controlled by the integrated switch mechanism 150. As shown in FIGS. 1-6, the integrated switch mechanism 150 is semi-automatic in nature. The integrated switch mechanism 150 comprises two conductor elements 151 (positive pole) and 152 (negative pole) that are configured to be connected and disconnected to the electrical connection port 139 of the grip element 136 of the jaw(s) 134.

When the jaw elements 135 of the pair of jaws 134 are in an engaged position (FIG. 1), then the two conductor elements 151 (positive pole) and 152 (negative pole) contact against the electrical connection port 139 of the grip element 136 of the jaw(s) 134, thereby automatically enabling an electrical connection (closed circuit) between the pair of blower fans 110 and the electrical connection port 139 of the grip element 136 of the jaw(s) 134. Thus, the pair of blower fans 110 automatically rotates when the jaw elements 135 of the pair of jaws 134 are in engaged position (FIG. 1) and vice-versa. The pair of blower fans 110 may further comprise manual control buttons (mechanical button for example, not shown in figures) to control the rotational speed of the pair of blower fans 110. It should be understood that the mount element 120 further comprises an internal wire/cable arrangement (not shown in figures) to enable electrical power to reach the pair of blower fans 110. The LED unit 160 is configured to emit a light when the jaw elements 135 of the pair of jaws 134 are in engaged position as shown in FIG. 1.

Further, in the scenario where the jaw elements 135 of the pair of jaws 134 are in the disengaged position (FIG. 6), the two conductor elements 151 (positive pole) and 152 (negative pole) do not contact against the electrical connection port 139 of the grip element 136 of the jaw(s) 134, thereby the electrical connection (closed circuit) between the pair of blower fans 110 and the electrical connection port 139 of the grip element 136 is not achieved. Thus, the pair of blower fans 110 are not rotating when the jaw elements 135 of the pair of jaws 134 are in disengaged position (FIG. 6). The LED unit 160 is configured to not emit light when the jaw elements 135 of the pair of jaws 134 are in disengaged position (FIG. 6).

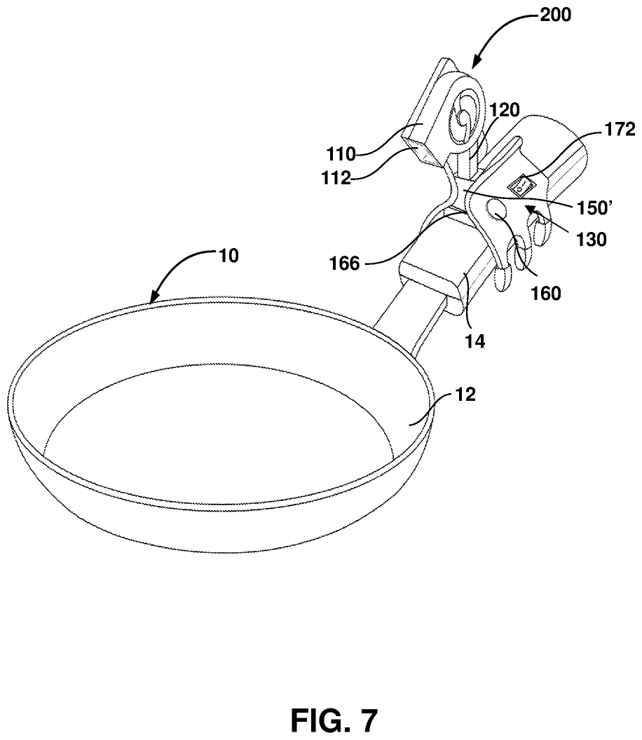

Referring to FIGS. 7-9, front perspective views, and a back perspective view of an overboiling protection device removably attached to a cooking utensil, according to another embodiment of the present invention. FIGS. 7-9 illustrates an overboiling protection device 200. The overboiling protection device 200 is similar to the overboiling protection device 100 of FIGS. 1-6, except for the modifications associated with the number of blower fans 110, and representing a more simplified design. Further, in the embodiment in FIGS. 7-9, the configuration of the pair of jaws 134 and the working principle of an integrated switch mechanism is seen changed.

As shown in FIGS. 7-9, the number of blower fans 110 in the overboiling protection device 200 is just one. Further, the overboiling protection device 200 comprises an integrated switch mechanism 150′ that is configured to electrically connect and disconnect the battery 165 to/from the blower fan 110 such that the rotation of the blower fan 110 is electrically controlled by the integrated switch mechanism 150′. The integrated switch mechanism 150′ is manual in nature. The integrated switch mechanism 150′ comprises a switch manual element 172 configured to be manually pressed by the user to allow rotation of the blower fan 110. Further, the user can prevent (switch off) rotation of the blower fan 110 by pressing the switch manual element 172. As shown in FIG. 7, the switch manual element 172 is a two-position electrical switch. However, in other embodiments (not shown in figures), the switch manual element 172 could include any manual switch including but not limited to: three position switch, rotary switch, toggle switch, knob type switch, push buttons, and so on. Further, as seen, the overboiling protection device 200 does not include any electrical connection port in the jaw(s) 134.

In another embodiment (not shown in figures), an overboiling protection device 300 is similar to the overboiling protection device 100 and 200 of FIGS. 1-9 except substitution (replacement) of the clip element 130 with other types of attachment mechanism. In this embodiment, the overboiling protection device 300 (not shown in figures) comprises at least one blower fan 110, and an attachment element 130′ (not shown in figures) configured to be removably attached to the cooking handle 14. The attachment element 130′ (not shown in figures) may include any mechanism such as but not limited to: Velcro fastener, magnetic couplings, snap-fit couplings, friction couplings, screw fasteners, pins, bayonet-locks, ropes, cables, straps, keys, and key-joints, cotter pins, and so on. A mount element 120 is configured to adjust the spatial position and/or rotational orientation of blower fan(s) 110 relative to the attachment element 130′.

Further, it should be understood that the various embodiments of the overboiling protection device (100, 200, 300) may also be employed for other applications apart from overboiling protection. For instance, the overboiling protection device (100, 200, 300) may be used for cooling down a high-temperature (hot) food item (for instance: a bowl of soup) or bite-sized portions of food item for ease of consumption. This may also be very beneficial for people with disabilities who may not be able to blow on hot food items to cool them down to a comfortable temperature and may aid in the prevention of spreading germs by eliminating human breath from the cooling process of food item (not shown in figures).

Further, it should be understood that the number of blower fan 110 may be any arbitrary number beginning from one such as but not limited to one, two, three, four, and so on depending on the requirements of the user. Further, it should be understood that the overboiling protection device (100, 200, 300) may be removably attached to any other surfaces (structures) capable of handling the weight (load) of the overboiling protection device (100, 200, 300) apart from the handle 14. For instance, the overboiling protection device (100, 200, 300) may be removably attached to the periphery of the cooking utensil 10 instead of the handle 14. In another instance, the overboiling protection device (100, 200, 300) may be removably attached to the kitchen shelf such that the ambient air provided by the blower fan(s) 110 is directed towards the food item placed in the cooking surface 12 of the cooking utensil 10.

Further, it should be well understood that the material of the overboiling protection device (100, 200, 300) is substantially thermal-resistant to resist heat arising from the cooking utensil 10.

Further, it should be understood that the parts/components associated with various embodiments of the overboiling protection device (100, 200, 300) are interchangeable. For instance, the parts/components associated with the overboiling protection device 100 (FIGS. 1-6) can also be used in the overboiling protection device 200 (FIGS. 7-9), and vice-versa.

In various embodiments as seen in FIGS. 1-9, the battery casing 166 enclosing a battery 165 (not shown) is positioned substantially below the integrated switch mechanism (150, 150′) such that the battery casing 166 and the integrated switch mechanism (150, 150′) are positioned substantially between the pair of jaws 134 of the overboiling protection device (100, 200, 300). However, it should be understood that the positioning arrangement of the battery casing 166, the integrated switch mechanism (150, 150′), and other parts/components of the overboiling protection device (100, 200, 300) can be further changed with respect to the pair of jaws 134 of the overboiling protection device (100, 200, 300) for ease in manufacturing assembly and/or better functionality.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. An overboiling protection device (100) removably couplable onto a cooking handle (14) of a cooking utensil (10), comprising:
at least one blower fan (110) configured to provide forced air directed towards food items placed on a cooking surface (12) of the cooking utensil (10);
an electrical power source (165) configured to power the at least one blower fan (110);
a clip element (130) configured to be removably attached to the cooking handle (14) of the cooking utensil (10), thereby mounting the overboiling protection device (100) to the cooking handle (14); and
a mount element (120) positioned between the at least one blower fan (110) and the clip element (130).

2. The overboiling protection device (100) of claim 1, wherein the mount element (120) is configured to adjust the position or rotational orientation of the at least one blower fan (110) relative to the clip element (130).

3. The overboiling protection device (100) of claim 1, wherein each of the at least one blower fan (110) comprises a duct (112) to direct forced conveyance of ambient air towards the cooking surface (12) in a forced manner.

4. The overboiling protection device (100) of claim 1, wherein the forced conveyance of ambient air eases the surface tension of the food item, thereby constantly returning the rising foam of the food item placed on the cooking surface (12) to a liquid state and dissipating the food item back into the cooking utensil (10).

5. The overboiling protection device (100) of claim 1, wherein the clip element (130) comprising:
a pair of jaws (134), wherein each jaw of the pair of jaws (134) comprises
a jaw element (135) configured to engage against the cooking handle (14),
a grip element (136) configured to be manipulated by the hands of the user, and
an intermediate element (137) rotationally connected to a biasing element (138).

6. The overboiling protection device (100) of claim 5, wherein the jaw element (135) comprises a plurality of non-slip coated tines (135A) for enabling a secure and efficient removable attachment between the jaw element (135) and the cooking handle (14).

7. The overboiling protection device (100) of claim 5, wherein one of the jaws selected from the pair of jaws (134) further comprises an electrical connection port (139) located in the grip element (136).

8. The overboiling protection device (100) of claim 5, wherein one of the jaws selected from the pair of jaws (134) further comprises an LED unit (160) to emit light when the jaw elements (135) of the pair of jaws (134) are in the engaged position.

9. The overboiling protection device (100) of claim 5, wherein the jaw elements (135) of the pair of jaws (134) are selectively positioned in either an engaged position or a disengaged position.

10. The overboiling protection device (100) of claim 9, wherein, in the engaged position, the jaw elements (135) of the pair of jaws (134) are distanced apart to removably receive the cooking handle (14) and in the disengaged position, the jaw elements (135) are brought closer to each other such that the cooking handle (14) is restricted from being received between the pair of jaw elements (135) of the pair of jaws (134).

11. The overboiling protection device (100) of claim 5, wherein the biasing element (138) extends along a substantial portion of the width of the pair of jaws (134) to enable the pair of jaws (134) to rotationally couple to each other, and automatically bring the pair of jaws (134) in the disengaged position unless acted upon by a force sufficient to overcome the resilient force provided by the biasing element (138).

12. The overboiling protection device (100) of claim 5, wherein the biasing element (138) is an element selected from a group of elements consisting of a torsion spring, a hinge, a leaf spring, a bellow, a gas spring, a helical spring.

13. The overboiling protection device (100) of claim 1, wherein the mount element (120) is a ball-socket joint capable of providing three degrees of freedom to enable the at least one blower fan (110) to rotate relative to the clip element (130) along three axes.

14. The overboiling protection device (100) of claim 1, wherein the mount element (120) comprises a mechanism selected from a group of mechanisms consisting of a slider mechanism, universal joints, revolute joints, Stewart platform, swivel joints, piston-cylinder mechanism.

15. The overboiling protection device (100) of claim 1, wherein the mount element (120) is rigidly positioned between the at least one blower fan (110) and the clip element (130) such that the position or rotational orientation of the at least one blower fan (110) remains unchangeable relative to the clip element (130).

16. The overboiling protection device (100) of claim 1 further comprising an integrated switch mechanism (150) electrically connecting and disconnecting the electrical power source 165) to and from the at least one blower fan (110).

17. The overboiling protection device (100) of claim 1, wherein the integrated switch mechanism (150) comprises a first conductor element (151), and a second conductor element (152) configured to connect and disconnect to the electrical connection port (139) of the grip element (136) of the jaw (134).

18. The overboiling protection device (100) of claim 1, wherein the at least one blower fan (110) further comprises at least one manual control button to control the rotational speed of the at least one blower fan (110).

19. The overboiling protection device (100) of claim 1, wherein the mount element (120) further comprises an internal cable arrangement to enable electrical power to reach the at least one blower fan (110).

20. An overboiling protection device (100) removably couplable onto a cooking handle (14) of a cooking utensil (10), comprising:
at least one blower fan (110) configured to provide forced air directed towards food items placed on a cooking surface (12) of the cooking utensil (10);
an electrical power source (165) configured to power the at least one blower fan (110);
an attachment element (130′) configured to be removably attached to the cooking handle (14) of the cooking utensil (10), thereby mounting the overboiling protection device (100) to the cooking handle (14); and
a mount element (120) positioned between the at least one blower fan (110) and the attachment element (130).

21. The overboiling protection device (100) of claim 20, wherein the attachment element (130′) is a mechanism selected from a group of mechanisms consisting of a Velcro fastener, magnetic couplings, snap-fit couplings, friction couplings, screw fasteners, pins, bayonet-locks, ropes, cables, straps, keys and key-joints, and cotter pins.

22. The overboiling protection device (100) of claim 20, wherein the forced conveyance of ambient air eases the surface tension of the food item, thereby constantly returning the rising foam of the food item placed on the cooking surface (12) to a liquid state and dissipating the food item back into the cooking utensil (10).
